(19) United States
(12) Patent Application Publication
(10) Pub. No.: US 2012/0019111 A1
(43) Pub. Date: Jan. 26, 2012

(54) Modular Equipment Enclosure

(76) Inventors: David Buescher, Strafford, MO (US); Mattew Calton, Strafford, MO (US)

(21) Appl. No.: 13/189,195

(22) Filed: Jul. 22, 2011

Related U.S. Application Data
(60) Provisional application No. 61/366,598, filed on Jul. 22, 2010.

(51) Int. Cl. A47B 87/00; B23P 17/00; B23P 11/00

(52) U.S. Cl. 312/109; 312/111; 29/428; 29/426.2

(57) ABSTRACT

A modular enclosure system for various types of equipment is provided. The modular enclosure system can be expanded to provide additional volume for equipment without removing or disconnecting equipment already installed in the enclosure. The system comprises a variety of components that may be configured and interconnected as necessary to provide the appropriate enclosure for a variety of equipment.

### RELATED APPLICATION

This application claims priority to U.S. Patent Application Ser. No. 61/366,598 filed on Jul. 22, 2010, which application is incorporated herein by reference.

### BACKGROUND OF THE INVENTION

1. Field of the Invention

The modular equipment enclosures described herein are weather-resistant enclosures for various types of electronic, telecommunication, or other gear that is sensitive to exposure to the elements, but that must be installed outside of typical buildings. Often certain equipment is installed at a certain location, and at a later time it becomes necessary to install additional equipment at the same location. It is typically desirable to interconnect the new equipment with the previously installed equipment. Currently, it may be necessary to remove all the equipment from the current enclosure and install a larger enclosure to contain the additional equipment.

Alternatively, a separate enclosure may be provided for the additional equipment, if the existing enclosure cannot be easily expanded. However, if the equipment in one enclosure must be connected to the equipment in the original enclosure, then complicated, expensive or labor-intensive connections must be made out of one enclosure and into the new enclosure.

It is desired to have an enclosure that can be readily expanded to hold additional equipment in a unitary enclosed volume, allowing simple and quick interconnection between equipment. It is also desired to have an enclosure that can be expanded without the need to remove or disconnect the equipment already installed in the enclosure.

2. Description of the Related Art

U.S. Pat. No. 6,945,616 B2 to Webster et al for MODULAR ENCLOSURE SYSTEM FOR ELECTRONIC EQUIPMENT describes a modular enclosure system that can be expanded to hold additional equipment. The '616 patent discloses a modular enclosure that may be expanded through a more complicated and less flexible process and system than that disclosed herein. The system of the '616 patent requires reconstruction of the enclosure to add space, whereas the system described herein is simple and easy to expand without reconstruction of the existing enclosure.

### SUMMARY OF THE INVENTION

An embodiment of the modular enclosure system comprises a plurality of cabinet modules, each cabinet module having an interior volume, an access door, and at least one interconnection port providing access to the interior volume from the exterior of the cabinet module; and at least one interconnection flange for releasably connecting to a first and second cabinet module of the plurality of cabinet modules adjacent to the interconnection ports thereof.

In embodiments of the system, the interconnection flange comprises a wall member having an interior and an exterior surface, and first and second end flanges disposed adjacent to the edges of the wall member and extending substantially perpendicular from the exterior surface of the wall member.

In some embodiments, a plurality of holes are provided in the first and second end flanges of the interconnection flange for receiving bolts, screws or clips for releasably attaching each end flange to one of the plurality of cabinet modules. The first and second end flanges of the interconnection flange may also be provided with seals for providing a weather-resistant connection between the interconnection flange and the exterior surface of the cabinet module.

In embodiments, the interconnection flange comprises four substantially rectangular side members joined along opposing edges to form an open-top and open-bottom box, and a first and second flange member attached to the top and bottom edges of the side members and extending perpendicularly outward therefrom.

A method for providing an expandable equipment enclosure according to the invention disclosed herein comprises the steps of providing a first cabinet module with an interconnection port; releasably attaching an interconnection flange to the first cabinet module adjacent to the interconnection port; providing a second cabinet module with an interconnection port; and releasably attaching the interconnection flange to the second cabinet module adjacent to the interconnection port.

The step of providing a first cabinet module with an interconnection port may further comprise the steps of: installing a first cabinet module at a desired location; installing equipment into the first cabinet module. The step of releasably attaching an inconnection flange to the first cabinet module may, in some embodiments, further comprise the steps of: removing the port cover from an interconnection port on the first cabinet module; positioning the interconnection flange with a first end flange of the interconnection flange against the first cabinet module adjacent to the interconnection port; and releasably attaching the interconnection flange to the first cabinet module with bolts, screws or clips.

In embodiments, the step of providing a second cabinet module may further comprise the steps of installing a second cabinet module with the interconnection port thereof disposed adjacent to the interconnection flange; and installing equipment into the second cabinet module.

In embodiments, the step of releasably attaching an inconnection flange to the second cabinet module may further comprise the steps of removing the port cover from an interconnection port on the second cabinet module; positioning the interconnection flange with a second end flange of the interconnection flange against the second cabinet module adjacent to the interconnection port; releasably attaching the interconnection flange to the second cabinet module with bolts, screws or clips.

In embodiments, the step of providing a second cabinet module may further comprise the step of connecting the equipment in the second cabinet module to the equipment in the first cabinet module.

### BRIEF DESCRIPTION OF THE DRAWINGS

FIG. 1 is an exploded perspective view of an embodiment of the modular equipment enclosure.

FIG. 2A is an exploded perspective view of an embodiment of the modular equipment enclosure.

FIG. 2B is a perspective view of an embodiment of the modular equipment enclosure.

FIG. 2C is a detailed perspective view of an embodiment of the modular equipment enclosure.

FIG. 3A is an cross-sectional view of a portion of an embodiment of the modular equipment enclosure.

FIG. 3B is a top plan view of an embodiment of the modular equipment enclosure.

FIG. 4 is a cross-sectional perspective view of an embodiment of the modular equipment enclosure.

FIG. 5 is a detail cross-sectional view of an embodiment of the modular equipment enclosure.

### DETAILED DESCRIPTION

The modular equipment enclosure provides an easily expandable enclosure for telecommunications, electronics or other types of equipment. The effective volume of an enclosure can be expanded in place by connecting additional modules to the original modules as described hereinafter. The expanded enclosure provides a unitary enclosure in which additional equipment may be installed in the new module and interconnected with equipment installed in other modules previously or concurrently installed in the enclosure. It is not necessary to remove the equipment already installed in a module prior to expanding the enclosure by interconnection of existing modules with one or more additional modules.

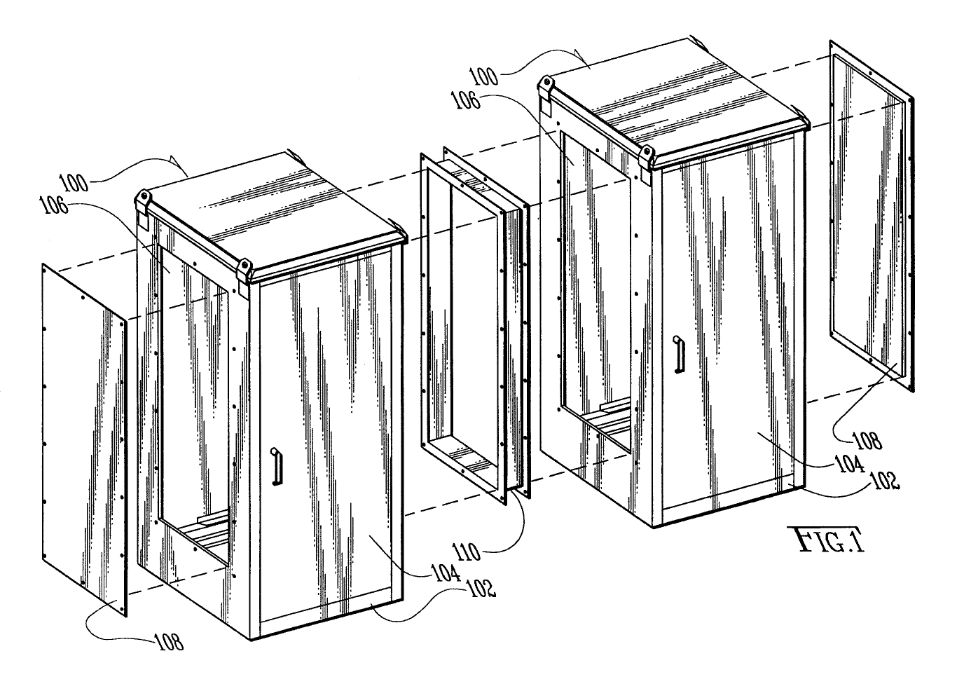

Referring now to FIG. 1, a perspective view of an embodiment of the modular equipment enclosure is depicted. The enclosure is comprised of one or more modules and other components for interconnecting the modules together to form an enclosure. The basic component of the system is the base cabinet module 100.

One module 100 can be used by itself to form an enclosure, or multiple modules 100 may be interconnected to form a larger enclosure. For example, single module 100 may be installed and be in use enclosing equipment of various kinds. When it is necessary to expand the enclosure to contain more equipment, one or more additional modules 100 may be installed and interconnected to the original module 100 without removing or disconnecting the equipment already installed in that module 100. The space enclosed by the additional modules is joined to the original module interior and equipment in the various modules may be interconnected as desired as though the equipment was located in the same module.

Module 100, in the depicted embodiment, comprises a cubical enclosure, although other shapes of enclosure may be utilized in other embodiments. Module 100 may be formed from metals, plastic, or any other material with the appropriate strength and other characteristics necessary for the system. The materials used for the construction of the module 100 are not limiting of the modular equipment enclosure described herein, and modules 100 of various materials may be connected together to form a single enclosure.

The module 100 may typically be formed of some structure of internal frame covered by sheets of material suitable to form the sides, but module 100 may also be formed by stamping or welding sheet materials into the appropriate shape and configuration. Module 100 may be installed on a base 102, or a base 102 may be formed as a part of module 100. Module 100 is also typically provided with an access door 104 to allow a user to access the enclosed space within. The access door 104 may be provided with a latch and may have means of locking the door shut to prevent unauthorized access to the interior of the module. The details of the structure of module 100 are not limiting of the modular equipment enclosure and may vary in embodiments of the modular enclosure system. Modules 100 of differing internal structures may be connected to form a single enclosure.

An interconnection port 106 is provided on one or more of the sides of the module 100 to allow for the interconnection of one module 100 with other modules 100. Typically, a module 100 may incorporate multiple interconnection ports 106 to allow the interconnection of numerous modules 100 together to form a single enclosure. When not in use to interconnect two modules 100, the interconnection port 106 is covered by a port cover 108 to define the interior of module 100. Port cover 108 or port 106, or both, may be provided with a seal to create a weather-tight joint between the cover 108 and the module 100, and cover 108 is releasably attached to the module 100 by screws, clips or similar means of releasable attachment.

An interconnection flange 110 is provided to secure two modules 100 to each other. The interconnection flange 110 may be provided in a variety of forms as necessary based on the shape and size of the module 100 and the interconnection port 106. In the embodiment depicted in the figures, the flange 110 is substantially rectangular in shape, with a substantially U-shaped cross-section comprising two lips, or end flanges, 112 and a rim, or wall, 114, as shown more clearly in reference to a later figure. The end flanges 112 are provided for securing to the modules 100 as described below. The wall 114 is of sufficient width to allow the modules 100 to be separated sufficiently to allow for proper seating of the modules on the base underlying the enclosure. The width of wall 114 may vary in differing embodiments of the modular enclosure system.

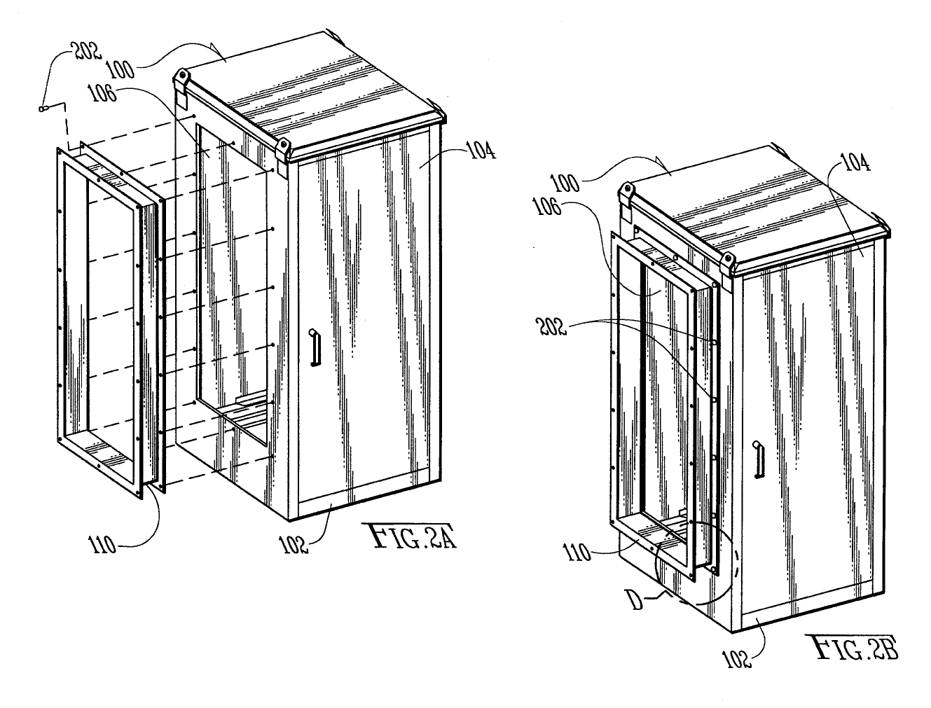

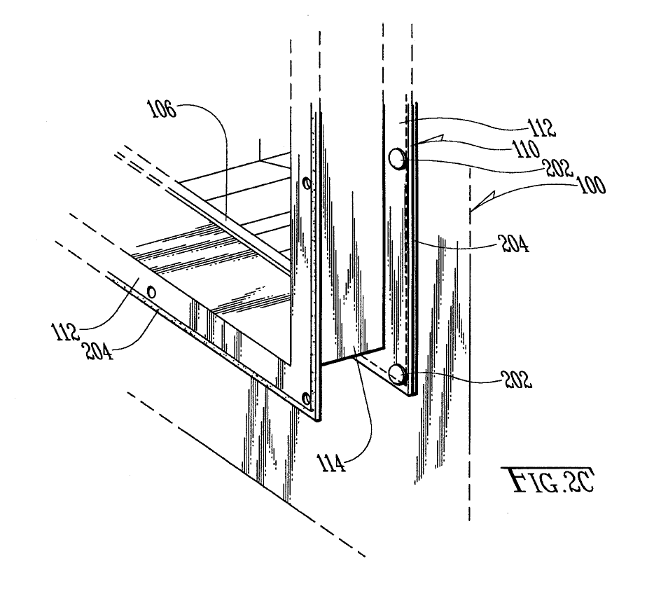

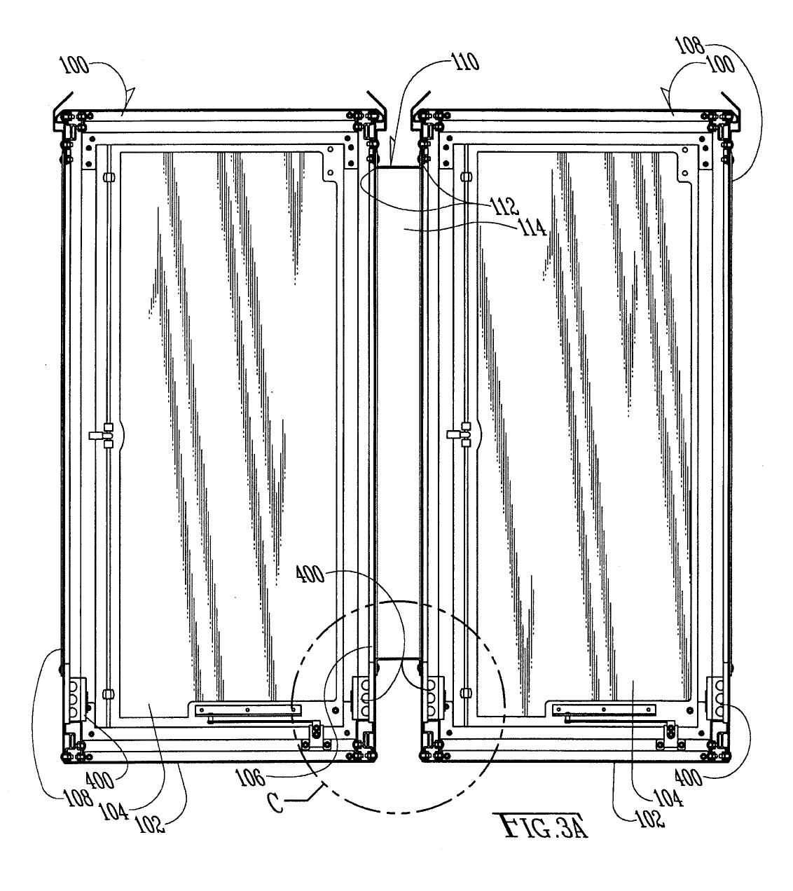

Referring now to FIGS. 2A, 2B and 2C, when two modules 100 are to be interconnected the covers 108 are removed from the respective interconnection ports 106. First the interconnection flange 110 is secured to the first module 100 at the interconnection port 106. Typically the flange 110 is secured by means of screws, bolts, clips, or other releaseable means 202 of securing two such parts together.

Releaseable means 202 secure the first end flange to the module 100. The flange 110 may utilize the same means of attachment by which cover 108 is secured to port 106, or other means of securing the flange 100 may be provided.

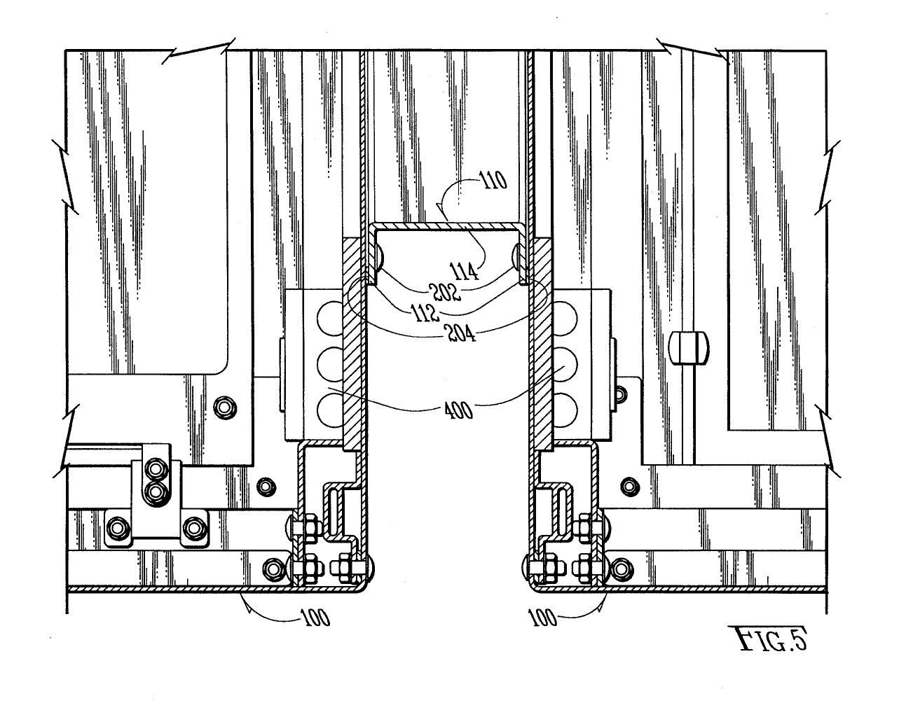

The wall 114 of the flange 110 extends the volume of space enclosed by the first module 100. The second module 100 is then positioned adjacent to the first module with its connection port 106 in communication with the second end flange 112 of flange 110. The second module is then releasably secured to the second end flange 112 of the interconnection flange 110 in a manner similar to that connecting the first module 100 to the first end flange 112 of the interconnection flange 110. The two module configuration can be seen in FIG. 1 in an exploded view, prior to attachment. FIG. 4, described below, depicts the cabinets in the final attached configuration.

Referring now to FIG. 2C, a detailed perspective view of an embodiment of the modular enclosure system is provided. Specifically, FIG. 2C depicts the area of FIG. 2B denoted by the dashed circle labeled D. The end flanges 112 and wall 114 of interconnection flange 110 are shown. In the embodiment shown in FIG. 2C, a weather seal 204 is provided adjacent to the outer edge of each end flange 112. The weather seal 204 may be formed from rubber, plastic, or other synthetic or natural materials suitable for use in a compressible weather seal.

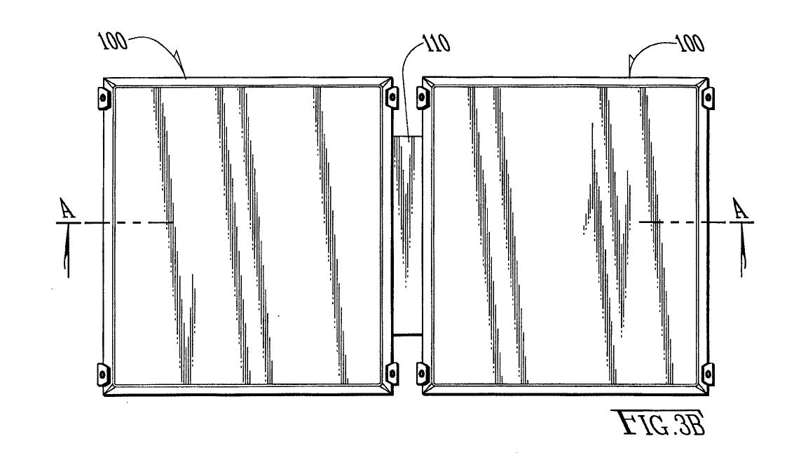

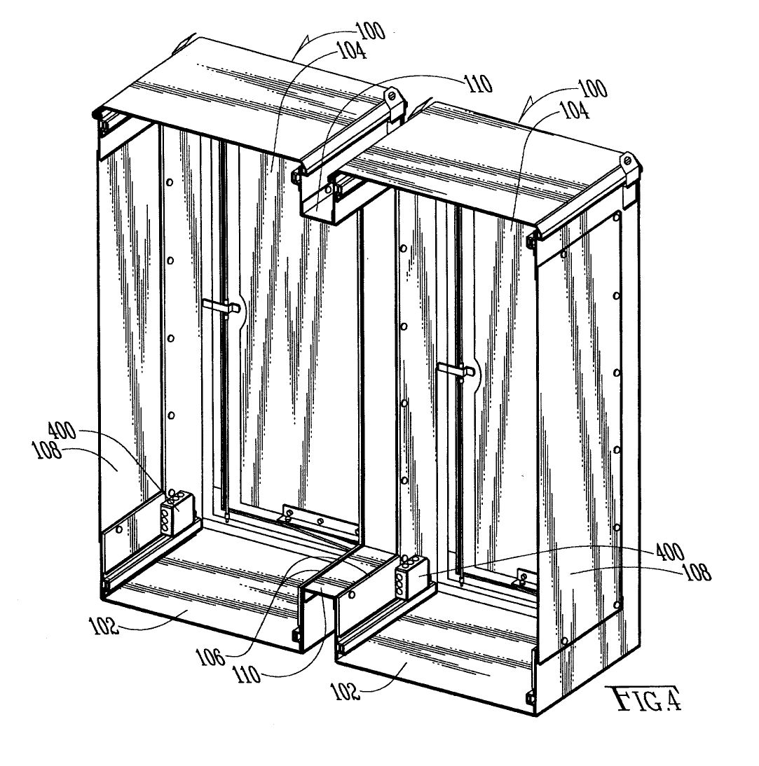

Referring now to FIGS. 3A and 3B, side and top cross-sectional plan views of an embodiment of the modular enclosure system are depicted. Two base cabinets 100 are shown attached to each other by interconnection flange 110. FIG. 3A depicts the cross-sectional view along dashed line A in FIG. 3B. As can be seen in FIG. 3B, the embodiment depicted in the figures incorporates modules 100 with square aspects when viewed from above. In other embodiments the modules 100 may have a rectangular aspect, or some other appropriate aspect as necessary for a specific type of module 100. Similarly, the vertical rectangular aspect of the modules 100 as seen in FIG. 3A is not limiting of the modular system, and other aspects, such as square, or otherwise, may be utilized as necessary.

Referring now to FIG. 4, a cross-sectional perspective view of an embodiment of the modular enclosure is depicted. In the configuration shown in FIG. 4, two modules 100 have been connected by an interconnection flange 110. The modules are shown without any internally installed equipment for clarity.

The combined interior volume of the cabinets 100 can clearly be seen in this figure. The interior volume of the cabinets 100 may be provided with mounting racks, not shown in this figure, for receiving various kinds of equipment to be installed in the cabinets. The interior of the cabinets 100 may be provided with external connectivity, such as electrical power outlets 400 or telecommunication interconnections.

Connections of various types, and even physical support structures such as racks, may extend through the interconnection flange and support and connect equipment located in both modules 100 simultaneously. The size of interconnection port 106 may vary in embodiments of the modular enclosure system described herein. For some uses, relatively small interconnection ports may be sufficient to provide the needed connection, while in other, larger connection ports may be required.

Equipment installed in a cabinet 100 may be directly connected to other equipment or external connections installed in another cabinet 100 through interconnection flange 110. In the embodiment shown, both cabinets 100 have an additional port cover 108 that may be removed and connected to another base cabinet 100, if necessary, further extending the volume that may be used to hold interconnected equipment. In other embodiments of the enclosure system, modules 100 may have more than two interconnection ports 106, and there may be more than one type of module provided with differing numbers or locations of interconnection ports 106.

Referring now to FIG. 5, a detailed cross-sectional view of a portion of an embodiment of the modular enclosure is depicted. Specifically, FIG. 5 depicts the area of FIG. 3A denoted by dashed circle C. The end flanges 112 are depicted connected to modules 100 by releaseable attachment 202 as described in relation to an earlier figure. Wall 114 provides separation between modules 100 as appropriate for property mounting.

As described above, the module enclosure system provides a reliable, convenient and easily expandable system for providing enclosures that may be expanded as necessary. The enclosures may be expanded by the additional of modules interconnected by flanges 100. The flanges 110 provide an easy and convenient way to provide additional storage in a previously installed enclosure without removing and reinstalling any equipment.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

What is claimed is:

1. A modular enclosure system comprising a first cabinet module and a second cabinet modules, each cabinet module having an interior volume, an access door, and at least one interconnection port providing access to the interior volume from the exterior of the cabinet module;
and at least one interconnection flange for releasably connecting to the first and second cabinet modules adjacent to the interconnection ports thereof.

2. The modular enclosure system of claim 1 wherein the interconnection flange comprises a wall member having an interior and an exterior surface, and first and second end flanges disposed adjacent to the edges of the wall member and extending substantially perpendicular from the exterior surface of the wall member.

3. The module enclosure system of claim 2 wherein a plurality of holes are provided in the first and second end flanges of the interconnection flange for receiving bolts, screws or clips for releasably attaching each end flange to one of the plurality of cabinet modules.

4. The module enclosure system of claim 3 wherein the first and second end flanges of the interconnection flange are provided with seals for providing a weather-resistant connection between the interconnection flange and the exterior surface of the cabinet module.

5. The module enclosure system of claim 2 wherein the interconnection flange comprises four substantially rectangular side members joined along opposing edges to form an open-top and open-bottom box, and a first and second flange member attached to the top and bottom edges of the side members and extending perpendicularly outward therefrom.

6. A method for providing a modular equipment enclosure comprising the steps of:
providing a first cabinet module with an interconnection port;
releasably attaching an interconnection flange to the first cabinet module adjacent to the interconnection port;
providing a second cabinet module with an interconnection port;
releasably attaching the interconnection flange to the second cabinet module adjacent to the interconnection port.

7. The method of claim 6 wherein the step of providing a first cabinet module with an interconnection port further comprises the steps of:
installing a first cabinet module at a desired location;
installing equipment into the first cabinet module.

8. The method of claim 7 wherein the step of releasably attaching an interconnection flange to the first cabinet module further comprises the steps of:
removing a port cover from an interconnection port on the first cabinet module;
positioning the interconnection flange with a first end flange of the interconnection flange against the first cabinet module adjacent to the interconnection port;
releasably attaching the interconnection flange to the first cabinet module with bolts, screws or clips.

9. The method of claim 8 wherein the step of providing a second cabinet module further comprises the steps of:
installing a second cabinet module with the interconnection port thereof disposed adjacent to the interconnection flange;
installing equipment into the second cabinet module.

10. The method of claim 9 wherein the step of releasably attaching an inconnection flange to the second cabinet module further comprises the steps of:
removing a port cover from an interconnection port on the second cabinet module;
positioning the interconnection flange with a second end flange of the interconnection flange against the second cabinet module adjacent to the interconnection port;
releasably attaching the interconnection flange to the second cabinet module with bolts, screws or clips.

11. The method of claim 9 wherein the step of providing a second cabinet module further comprises the step of connecting the equipment in the second cabinet module to the equipment in the first cabinet module.

12. A modular equipment enclosure comprising a first cabinet module, a second cabinet module and an interconnection flange with a first end and a second end, wherein the first end of the interconnection flange is releaseably connected to an interconnection port in the first cabinet module, and the second end of the interconnection flange is releaseably connected to an interconnection port in the second cabinet module.

13. The modular equipment enclosure of claim 12 wherein the interconnection flange comprises a wall member extending from the first end of the interconnection flange to the second end of the interconnection flange; and a first end flange connected to the wall member at the first end of the interconnection flange; and a second end flange connected to the wall member at the second end of the interconnection flange.

14. The modular equipment enclosure of claim 13 wherein the first end flange and the second end flange are attached to the first and second cabinets with bolts, screws, clips, or rivets.

15. The modular equipment enclosure of claim 14 wherein the first end flange and the second end flange are provided with weather-resistant seals.

16. The modular equipment enclosure of claim 15 wherein the first and second cabinets comprise an enclosure with four side walls, a top member and a bottom member; wherein a first side wall has a door for accessing the inside of the enclosure; and whereas at least one side wall has an interconnection port with a removable cover.

17. The modular equipment enclosure of claim 16 wherein the inside of each cabinet may be accessed from the other cabinet through the interconnection port.
